(19) United States
(12) Patent Application Publication
(10) Pub. No.: US 2026/0291082 A1
(43) Pub. Date: Sep. 24, 2026

(54) ANTENNA STRUCTURE AND COMMUNICATION DEVICE

(71) Applicant: HUAWEI TECHNOLOGIES CO., LTD., Shenzhen (CN)

(72) Inventors: Li Jin, Xi'an (CN); Weimin Li, Xi'an (CN); Weihong Xiao, Dongguan (CN); Xiaogang Xue, Dongguan (CN); Xiangyang Cui, Xi'an (CN)

(73) Assignee: HUAWEI TECHNOLOGIES CO., LTD., Shenzhen (CN)

(21) Appl. No.: 19/677,635

(22) Filed: May 14, 2026

Related U.S. Application Data
(63) Continuation of application No. PCT/CN2024/116605, filed on Sep. 3, 2024.

(30) Foreign Application Priority Data
Nov. 16, 2023 (CN) 202311537968.3

(51) Int. Cl. H01Q 19/10; H01Q 1/42; H01Q 21/00

(52) U.S. Cl. CPC H01Q 19/10; H01Q 1/42; H01Q 21/00

(57) ABSTRACT

Embodiments of this application provide an antenna structure and a communication device, and relate to the field of radio communication technologies. The antenna structure includes a radome, an antenna array assembly, a mounting base, and a connector. The radome has a first accommodating cavity, and the antenna array assembly and the mounting base are both disposed in the first accommodating cavity. The antenna array assembly has a radiation surface and a back surface facing away from the radiation surface, and is provided with a preset port. The mounting base includes a mounting base body, the mounting base is located on a side on which the back surface of the antenna array assembly is located, and the mounting base body is provided with a second accommodating cavity. The connector is disposed in the second accommodating cavity, and the connector is electrically connected to the preset port.

### CROSS-REFERENCE TO RELATED APPLICATIONS

This application is a continuation of International Application No. PCT/CN2024/116605, filed on Sep. 3, 2024, which claims priority to Chinese Patent Application No. 202311537968.3, filed on Nov. 16, 2023. The disclosures of the aforementioned applications are hereby incorporated by reference in their entireties.

### TECHNICAL FIELD

The present invention relates to the field of radio communication technologies, and in particular, to an antenna structure and a communication device.

### BACKGROUND

An antenna structure is a key part of a wireless communication system, and performance of the antenna structure directly determines communication quality of the wireless system.

In a conventional antenna structure, a connector of the antenna structure is mounted at the bottom of the antenna structure, and performs radio frequency signal transmission with an antenna array. The antenna structure is vertically mounted on a pole, and a remote radio unit (remote radio unit, RRU) is connected to the connector of the antenna structure through a jumper, to implement radio frequency signal transmission.

However, in the conventional antenna structure, the connector is far away from a signal connection port of the antenna array, which leads to a high transmission loss.

### SUMMARY

An objective of the present invention is to provide an antenna structure and a communication device, to reduce a transmission loss in the antenna structure.

To achieve the foregoing objective, the following technical solutions are used in embodiments of this application.

According to an aspect of embodiments of this application, an antenna structure is provided. The antenna structure includes a radome, an antenna array assembly, a mounting base, and a connector. The radome has a first accommodating cavity, and the antenna array assembly and the mounting base are both disposed in the first accommodating cavity. The antenna array assembly has a radiation surface and a back surface facing away from the radiation surface, and is provided with a preset port. The mounting base includes a mounting base body, the mounting base is located on a side on which the back surface of the antenna array assembly is located, and the mounting base body is provided with a second accommodating cavity. The connector is disposed in the second accommodating cavity, and the connector is electrically connected to the preset port.

It can be learned from the foregoing descriptions that the antenna array assembly has the radiation surface and the preset port. The connector is electrically connected to the preset port. A radio frequency signal is transmitted to the connector, and the radio frequency signal is transmitted to the preset port through the connector, so that the antenna array assembly transmits a radio wave through the radiation surface. Therefore, the antenna structure can transmit the radio wave. Alternatively, after the radiation surface of the antenna array assembly receives a radio wave signal, the antenna array assembly transmits a radio frequency signal to the connector through the preset port, and transmits the radio frequency signal to the outside of the antenna structure through the connector. Therefore, the antenna structure can receive the radio wave signal. Therefore, when the connector is electrically connected to the preset port, an external apparatus can transmit a radio frequency signal to the preset port of the antenna array assembly through the connector, so that the antenna array assembly transmits a radio wave through the radiation surface. In addition, after the radiation surface of the antenna array assembly receives a radio wave signal, the antenna array assembly transmits a radio frequency signal to the connector through the preset port, and transmits the radio frequency signal to the external apparatus through the connector, to complete radio frequency signal exchange between the antenna array assembly and the external apparatus. In addition, the antenna structure may further include the mounting base. The mounting base may be located in the first accommodating cavity, and the mounting base body of the mounting base has the second accommodating cavity capable of accommodating the connector, so that the mounting base can accommodate and protect the connector. The antenna array assembly and the mounting base are located in the first accommodating cavity of the radome, so that the antenna array assembly and the mounting base can be protected by using the radome, to reduce impact of an external environment on the antenna array assembly and the mounting base. In this case, in the antenna structure provided in this application, the connector is disposed in the second accommodating cavity of the mounting base body. Because the mounting base body is located in the first accommodating cavity, the connector is located in the first accommodating cavity. In addition, the mounting base is fastened to the side on which the back surface of the antenna array assembly is located, so that the connector can be located on the back surface of the antenna array assembly. In this case, a distance between the connector and the preset port of the antenna array assembly is short. In addition, a disposition position of the mounting base may be adjusted, to enable the mounting base to be disposed close to the preset port, so that the distance between the connector and the preset port is reduced, and a signal transmission loss between the connector and the preset port is reduced. In a related technology, the connector is disposed at the bottom of the antenna structure, a distance between the connector and the preset port is long, and a loss during signal transmission is high. However, in the antenna structure provided in embodiments of this application, the distance between the connector and the preset port is short. Therefore, the transmission loss between the connector and the preset port can be reduced. In this way, the transmission loss in the antenna structure is reduced.

In some embodiments of this application, the connector may be directly electrically connected to the preset port. The disposition position of the mounting base is adjusted, to enable the mounting base to be close to the preset port, so that the connector can be directly electrically connected to the preset port. In this case, in a radio frequency signal transmission process, the connector directly transfers a radio frequency signal to the preset port, or the preset port directly transfers a radio frequency signal to the connector. That is, when radio frequency is transferred between the preset port and the connector, no path loss is caused. In this way, the transmission loss in the antenna structure is further reduced.

In some other embodiments of this application, the antenna structure may further include a first cable. The first cable is disposed in the first accommodating cavity, a first end of the first cable is electrically connected to the preset port, and a second end of the first cable is electrically connected to the connector. When the mounting base cannot be mounted close to the preset port due to a limitation of mounting space on the side on which the back surface of the antenna array assembly is located, and therefore the connector cannot be directly electrically connected to the preset port, the connector may be electrically connected to the preset port via the first cable. In this case, a radio frequency signal may be transmitted between the connector and the preset port via the first cable. In addition, both the connector and the first cable that is configured to electrically connect the connector to the preset port of the antenna array assembly are located on the back surface of the antenna array assembly. In this way, the first cable and the connector are located on a same side of the antenna array assembly, and a length of the first cable can be reduced. In the related technology, the connector is disposed at the bottom of the antenna structure, in other words, a length of a feeder configured to electrically connect the connector to the preset port needs to be greater than a distance between the bottom of the radome and the preset port. Consequently, the length of the feeder is long, and a transmission loss is high. In the antenna structure provided in embodiments of this application, the mounting base may be disposed close to the preset port, so that the distance between the connector and the preset port is reduced, the required length of the first cable is reduced, and the transmission loss in the antenna structure is reduced. In some embodiments of this application, the mounting base body may be provided with a mounting hole. An end that is of the connector and that is close to the antenna array assembly passes through the mounting hole, and is electrically connected to the preset port. The mounting hole is provided at a position that is of the mounting base body and that is close to the preset port, so that it is ensured that the connector can be directly electrically connected to the preset port. Alternatively, when the connector needs to be electrically connected to the preset port via the first cable, the first cable may be electrically connected to the connector on an outer side of the mounting base body. In this case, the first cable can be electrically connected to the connector without bypassing the mounting base body or extending into the second accommodating cavity, so that the length of the first cable can be further reduced, and a transmission loss of the first cable can be further reduced.

In some embodiments of this application, the second accommodating cavity is a groove, an opening of the groove faces away from the back surface, the groove has a first groove wall on a side close to the preset port, and the first groove wall is provided with the mounting hole. In conclusion, the mounting hole is provided on the first groove wall that is of the groove and that is on the side close to the preset port, and one end of the connector is electrically connected to the preset port or the first cable after passing through the mounting hole. In this case, the end of the connector exceeds a side wall of the groove, and is located on a side that is of the mounting base body and that is close to the preset port. When a distance between the mounting base body and the preset port is fixed, a distance between the end that is of the connector and that passes through the mounting hole and the preset port is short, so that the transmission loss between the preset port and the connector is low, and the transmission loss in the antenna structure is further reduced.

In some embodiments of this application, a plane on which the first groove wall is located may intersect the back surface, an included angle between the plane on which the first groove wall is located and the back surface is a first included angle α, an opening of the first included angle α faces the preset port, and 0°<α≤90°. For example, the first included angle α is 5°, 25°, 45°, 65°, 80°, 90°, or the like. When the connector needs to be electrically connected to the preset port via the first cable, the first groove wall is provided with the mounting hole, and the end of the connector passes through the mounting hole and is electrically connected to the first cable. The opening of the first included angle α between the first groove wall and the back surface faces the preset port. In other words, the preset port, the end that is of the connector and that passes through the mounting hole, and the first cable configured to connect the preset port and the connector are all located on a same side of the first groove wall. In this case, the required length of the first cable is short. In addition, when α=90°, the first groove wall is perpendicular to the back surface, and an axis of the mounting hole provided on the first groove wall is parallel to the back surface. After the end of the connector passes through the mounting hole, an extension direction of the end is parallel to the back surface. In addition, the end that is of the connector and that passes through the mounting hole, the preset port, and the first cable are all located on the same side of the first groove wall. In this case, when the first cable communicates with the connector and the preset port, an extension direction of the second end of the first cable is parallel to the back surface, and the first cable can be connected to the connector without bending. When 0°<α<90°, an end that is of the first groove wall and that is away from the back surface is inclined toward the preset port. After the end of the connector passes through the mounting hole, an extension direction of the end that is of the connector and that passes through the mounting hole faces the back surface, and an extension direction of the second end of the first cable configured to electrically connect to the connector faces away from the back surface. In this case, the first cable needs to be bent only once in a direction facing away from the back surface. After bending, an angle of a bent portion is greater than 90°, and a bending degree is small, so that bending is easy. When the first included angle α is greater than 90°, an extension direction of the second end of the first cable needs to face the back surface. When the first cable is connected to the preset port and the connector, the first cable needs to be first bent in a direction facing away from the back surface, and then bent in a direction facing the back surface. That is, the first cable needs to be bent at least twice. In addition, a bending angle of the first cable at a connection portion with the connector is small, and a bending degree is large. In this case, mounting is inconvenient, and a required length of the first cable is long. Therefore, when the first cable in the antenna structure provided in embodiments of this application is connected to the connector, the first cable does not need to be bent or needs to be bent only once, and an angle at a bent portion is large, so that mounting of the first cable and the connector is facilitated, and the length of the first cable can be reduced. Therefore, mounting convenience of the antenna structure can be improved, and the transmission loss of the first cable can be reduced.

In some embodiments of this application, the groove may have a second groove wall, there is a second included angle β between the first groove wall and the second groove wall, and 45°≤β<180°. For example, the second included angle β is 45°, 60°, 90°, 120°, 135°, 150°, 175°, or the like. In this case, because an opening of the second included angle between the first groove wall and the second groove wall is large, operable space for a worker is increased when an external cable extends into the groove and is connected to the connector, thereby facilitating mounting of the external cable and the connector. However, when the groove has a uniform groove depth and the second included angle β between the first groove wall and the second groove wall is less than 45°, the opening of the groove is small. In this case, when an external cable extends into the groove and is connected to the connector, operable space for a worker is small, and connection is difficult. Therefore, the antenna structure provided in embodiments of this application facilitates mounting of the external cable and the connector, so that mounting and maintenance convenience of the antenna structure and the external cable is improved.

In some embodiments of this application, the second groove wall is provided with the mounting hole. When a plurality of groups of radio frequency signals are exchanged between the preset port and the external apparatus, the antenna structure requires a large quantity of connectors, and different connectors each can pass through the mounting hole provided on the first groove wall or the second groove wall and be electrically connected to the preset port, to ensure that a quantity of connectors that can be accommodated in the groove meets a requirement.

In some embodiments of this application, the mounting base may further include a reinforcing rib, the reinforcing rib is disposed between the first groove wall and the second groove wall, and the reinforcing rib is connected to at least one of the first groove wall and the second groove wall. The reinforcing rib can improve connection rigidity between the first groove wall and the second groove wall, to improve structural stability of the mounting base.

In some embodiments of this application, the second accommodating cavity may be a groove, and an opening of the groove faces away from the back surface; and a bottom of the groove is provided with the mounting hole, and the bottom of the groove is parallel to the back surface. In this case, an axis of the mounting hole provided at the bottom of the groove is perpendicular to the back surface. After one end of the connector passes through the mounting hole, an extension direction of the connector is perpendicular to the back surface, and the connector is disposed at the bottom of the groove. When mounting space of the mounting base is small, and the groove has a small depth, the connector can be accommodated in the groove.

In some embodiments of this application, the groove may have a plurality of groove walls, there is a third included angle γ between the groove wall and the bottom, and 80°≤γ<100°. For example, the third included angle γ is 80°, 85°, 90°, 95°, or 100°. In this case, a projection area of the bottom of the groove on the back surface is close to or the same as a projection area of an open end of the groove on the back surface. In a direction parallel to the back surface, when assembly space of the mounting base is limited, that is, when the projection area of the bottom of the groove on the back surface is the same as the projection area of the open end of the groove on the back surface, when 80°≤γ<100°, space of the groove is large, and a large quantity of connectors can be accommodated, so that it is ensured that a quantity of connectors that can be accommodated in the groove meets a requirement. However, when the third included angle γ is less than 80°or greater than 100°, a groove wall tilt degree is large. When the projection area of the bottom of the groove on the back surface is the same as the projection area of the open end of the groove on the back surface, the space of the groove is small. Therefore, the groove in the antenna structure provided in embodiments of this application can accommodate more connectors, to meet a transmission requirement of a radio frequency signal of the antenna array assembly.

In some embodiments of this application, the groove may have a plurality of groove walls that intersect with the bottom, and at least one of the groove walls may be provided with the mounting hole. When the antenna structure requires a large quantity of connectors, the connectors each can be mounted at the bottom or on the groove wall, to ensure that a quantity of connectors that can be accommodated in the groove meets a requirement.

In some embodiments of this application, the connector and the mounting base body may be connected in a sealed manner at the mounting hole. For example, a sealing ring is disposed on the mounting base body at the mounting hole, and the sealing ring is sleeved at an end that is of the connector and that is close to the antenna array assembly; or an inner wall of the mounting hole is coated with sealant, and one end that is of the connector and that is close to the antenna array assembly is connected to the inner wall of the mounting hole in a sealed manner by using the sealant. In this case, the second accommodating cavity of the mounting base body is sealed relative to the first accommodating cavity of the radome at the mounting hole, to prevent moist air in the second accommodating cavity from entering the first accommodating cavity, which causes component corrosion in the first accommodating cavity and affects performance of the antenna structure. In this way, working stability and service life of the antenna structure are improved.

In some embodiments of this application, the mounting base may further include a mounting bracket, the mounting bracket may be disposed on a side that is of the back surface and that faces the mounting base body, one end of the mounting bracket is connected to the mounting base body, and the other end of the mounting bracket is connected to the antenna array assembly. The mounting bracket is connected to the mounting base body and the antenna array assembly, and the mounting base body and the antenna array assembly are fastened relative to each other through the mounting bracket. In this case, the mounting bracket can support the mounting base body, and a distance between the mounting base body and the back surface of the antenna array assembly can be increased by using the mounting bracket, so that it is ensured that the connector in the first accommodating cavity is close to an inner wall that is of the radome and that faces away from the back surface, and connection and mounting of the connector and the external cable are facilitated.

In some embodiments of this application, the mounting bracket may have assembly space, and the mounting base body is disposed in the assembly space. The assembly space may be space enclosed by a framework of the mounting bracket. After the mounting base body is disposed in the assembly space, the mounting bracket can protect the mounting base body, to prevent the mounting base body from being deformed by force, which affects connection stability between the connector and the mounting base body.

In some embodiments of this application, the second accommodating cavity may be a groove, and an opening of the groove faces away from the back surface; and the mounting base may further include a flange, the flange is fastened at an open end of the groove, and the flange is connected to the radome. In this case, the mounting base body may be fastened to the radome by using the flange. In addition, the flange is disposed on a peripheral side of the open end of the groove, and does not block the opening of the groove, so that connection space between the connector and the external cable in the groove is ensured. In addition, the flange can increase an area of a connection portion between the mounting base and the radome, to facilitate hole forming or glue application on the flange, and ensure that the mounting base and the radome are fastened relative to each other.

In some embodiments of this application, the radome may be provided with a first connecting hole, and the first connecting hole is in communication with the second accommodating cavity. In this case, the external cable can be electrically connected to the connector in the second accommodating cavity through the first connecting hole, so that mounting convenience of the external cable is improved. In addition, when the external cable is connected, the connector does not need to be pulled out of the radome, so that mounting is easy.

In some embodiments of this application, the antenna structure may further include a waterproof member, and the waterproof member is disposed on an outer side of a panel that is of the radome and that has the first connecting hole. The waterproof member includes a waterproof member body and a boss, the waterproof member body is provided with a second connecting hole, and the second connecting hole is in communication with the first connecting hole. The boss is disposed on a side that is of the waterproof member body and that is close to the mounting base, and one end of the boss extends into the first connecting hole and abuts against the mounting base. After the boss of the waterproof member abuts against the mounting base, the connection portion between the mounting base and the radome can be blocked, and waterproof performance at the connection portion between the mounting base and the radome is improved. In addition, the waterproof member has the second connecting hole that is in communication with the first connecting hole, and the external cable can sequentially pass through the second connecting hole and the first connecting hole and be electrically connected to the connector in the second accommodating cavity, so that mounting convenience of the external cable is ensured.

In some embodiments of this application, the antenna structure may further include a first sealing member, and the first sealing member is disposed between the waterproof member and the radome. For example, the first sealing member is a waterproof strip, a sealing ring, or the like. The first sealing member ensures sealing performance between the waterproof member and the radome, prevents moist air or rainwater from entering the connection portion between the radome and the mounting base through a connection portion between the waterproof member and the radome and finally entering the first accommodating cavity, and protects a component in the first accommodating cavity from being corroded by the moist air or the rainwater, which affects working performance of the antenna structure. In this way, working stability and service life of the antenna structure are improved.

In some embodiments of this application, the antenna structure may further include a second sealing member, and the second sealing member is disposed between the mounting base and the radome. For example, the second sealing member is a waterproof strip, a sealing ring, or the like. The second sealing member ensures sealing performance between the mounting base and the radome, prevents moist air or rainwater from entering the first accommodating cavity through the connection portion between the radome and the mounting base, and protects a component in the first accommodating cavity from being corroded by the moist air or the rainwater, which affects working performance of the antenna structure. In this way, working stability and service life of the antenna structure are improved.

In some embodiments of this application, the antenna structure may further include a first connecting member. The mounting base may be provided with a first fastening hole, and the radome may be provided with a second fastening hole. The first connecting member sequentially passes through the second fastening hole and the first fastening hole, and is fastened to the mounting base. For example, the first connecting member is a bolt or a screw, and the first fastening hole is a threaded hole. After passing through the second fastening hole, the first connecting member is threaded into the first fastening hole, so that it is ensured that the mounting base is fastened to the radome. Alternatively, the first connecting member is a pin, and the first fastening hole is a pin hole. After passing through the second fastening hole, the first connecting member is connected to the first fastening hole in an interference fit, so that it is ensured that the mounting base is fastened to the radome. After the first connecting member is fastened to the mounting base, force bringing the mounting base and the radome closer to each other may be applied, to ensure that the mounting base and the radome are fastened relative to each other, and enable the mounting base and the radome to be closely attached, so that sealing performance of the connection portion between the mounting base and the radome is improved.

In some embodiments of this application, the antenna array assembly may include a reflector and a plurality of radiating elements arranged in an array. The radiation surface of the antenna array assembly is an end face that is of the radiating element and that faces away from the reflector, and the reflector has a reflective surface close to the radiation surface. The radiating element may transmit or receive a radio wave, and the reflective surface of the reflector may reflect the radio wave, so that the radio wave is aggregated at a receiving point of the radiating element, thereby enhancing a receiving capability of the radiating element. In addition, the back surface of the antenna array assembly is an end face that is of the reflector and that faces away from the radiation surface, and the preset port is disposed on the end face that is of the reflector and that faces away from the radiation surface. The antenna array assembly may further include a feed network. The feed network is electrically connected to the radiating element, and the feed network is electrically connected to the preset port. After receiving a radio wave, the radiating element transmits a radio frequency signal to the preset port through the feed network, and then transmits the radio frequency signal to the outside of the antenna array assembly through the preset port. Alternatively, after transmitting a radio frequency signal to the preset port, the external apparatus transmits the radio frequency signal to the radiating element through the feed network. After receiving the radio frequency signal, the radiating element transmits a radio wave to the outside. The preset port is electrically connected to the connector, and is electrically connected to the external apparatus through the connector. Finally, the radiating element can receive or transmit a radio wave, and perform signal transmission with the external apparatus.

In some embodiments of this application, a distance between a first inner wall of the radome and an end that is of the connector and that faces away from the antenna array assembly is a first distance h₁, a distance between the first inner wall and an end face that is of the mounting base and that is away from the back surface is a second distance h₂, and h₁≥h₂. The first inner wall is an inner wall of the radome on a side that is of the mounting base and that faces away from the back surface. In this case, the end that is of the connector and that faces away from the antenna array assembly does not protrude beyond an end face of the mounting base. When the radome is sleeved on an assembly in which the antenna array, the reflector, the mounting base, and the connector have been assembled, the connector does not generate friction with the inner wall of the radome, so that a passive intermodulation (passive intermodulation, PIM) problem caused by repeated friction between the radome and the connector in a radome assembly process is avoided. In addition, the mounting base provides protection for the connector, so that the connector is further protected.

In some embodiments of this application, there are at least two preset ports, there are at least two first cables, a midpoint between two preset ports that are farthest from each other is a first position, a distance between the mounting base and the first position is a first length, and the first length is less than a distance between the mounting base and any preset port. When there are at least two preset ports, the distance between the mounting base and the first position is less than the distance between the mounting base and any preset port, that is, the mounting base is located between the at least two preset ports. In this case, a sum of distances between the mounting base and the preset ports is small, so that a required total length of the first cables is reduced, and the transmission loss is reduced.

In some embodiments of this application, the preset port includes at least two connectors, the antenna structure includes at least two first cables and at least two connectors, first ends of the first cables are electrically connected to terminals of the preset port in one-to-one correspondence, and second ends of the first cables are electrically connected to the connectors in one-to-one correspondence. When the preset port needs to perform transmission of a plurality of groups of radio frequency signals with the outside, the preset port can be electrically connected to the corresponding first cables through different terminals, the first cable is electrically connected to the corresponding connector, and the connector is configured to electrically connect to the outside, so that the preset port has a plurality of signal transmission paths to the outside, to implement transmission of the plurality of groups of radio frequency signals.

According to another aspect of embodiments of this application, a communication device is provided. The communication device may include any one of the foregoing antenna structures. The communication device may further include a communication bracket, a second cable, and a remote radio unit. The antenna structure and the remote radio unit are separately disposed on the communication bracket. One end of the second cable is electrically connected to the end that is of the connector of the antenna structure and that faces away from the antenna array assembly, and the other end of the second cable is electrically connected to the remote radio unit. The communication device has same technical effect as the antenna structure provided in the foregoing embodiment. Details are not described herein again.

In some embodiments of this application, the remote radio unit is disposed on an outer wall of the radome of the antenna structure. In this case, a distance between the remote radio unit and the connector is short, and when the connector is electrically connected to the remote radio unit via the second cable, a required length of the second cable is short, so that a transmission loss of the second cable is reduced. In this way, a radio frequency signal transmission loss between the antenna structure and the remote radio unit is reduced.

In some embodiments of this application, the antenna structure may further include a support frame disposed in the first accommodating cavity and a second connecting member. In addition, the radome is provided with a third fastening hole. One end of the second connecting member passes through the third fastening hole and is connected to the support frame, and the other end of the second connecting member is connected to the remote radio unit. In this case, the remote radio unit is connected to the support frame through the second connecting member, and is fastened relative to the support frame. The support frame supports and fastens the remote radio unit, so that the remote radio unit can be stably disposed on a side wall of the radome.

In some embodiments of this application, the antenna structure may further include a support base. The support base is disposed on an outer wall of the radome on the side that is of the mounting base and that faces away from the back surface, and is connected to the remote radio unit. In addition, the support base is provided with a fourth fastening hole, and the end of the second connecting member sequentially passes through the fourth fastening hole and the third fastening hole and is connected to the support frame. After the second connecting member passes through the fourth fastening hole and the third fastening hole and is connected to the support frame, the support base, the radome, and the support frame are fastened relative to each other. Then, the remote radio unit is connected to the support base, so that the remote radio unit is fastened to the outer wall of the radome.

### BRIEF DESCRIPTION OF DRAWINGS

FIG. 1 is a diagram of a structure of a communication system architecture according to an embodiment of this application;

FIG. 2 is a diagram of a structure of a communication device according to an embodiment of this application;

FIG. 3A is a diagram of a structure of an antenna structure according to an embodiment of this application;

FIG. 3B is an exploded view of the antenna structure shown in FIG. 3A;

FIG. 3C is another exploded view of the antenna structure shown in FIG. 3A;

FIG. 3D is a diagram of an antenna array assembly in FIG. 3B in a direction A;

FIG. 4 is an exploded view of another antenna structure according to an embodiment of this application;

FIG. 5A is a diagram of a structure of a mounting base according to an embodiment of this application;

FIG. 5B is an exploded view of a mounting base body and an antenna array assembly according to an embodiment of this application;

FIG. 6 is an assembly diagram of a first cable, a connector, and a second cable on a first groove wall when α is greater than 90°;

FIG. 7 is an assembly diagram of a first cable, a connector, and a second cable on a first groove wall when α is less than 90°;

FIG. 8 is an assembly diagram of a first cable, a connector, and a second cable on a first groove wall when α is equal to 90°;

FIG. 9 is a diagram of a structure of another mounting base according to an embodiment of this application;

FIG. 10 is a diagram of a structure of still another mounting base according to an embodiment of this application;

FIG. 11 is an exploded view of still another antenna structure according to an embodiment of this application;

FIG. 12 is a diagram of a structure of yet another mounting base according to an embodiment of this application;

FIG. 13 is an exploded view of yet another antenna structure according to an embodiment of this application;

FIG. 14 is a diagram of a structure of a radome according to an embodiment of this application;

FIG. 15 is a diagram of positions of a mounting base and a radome according to an embodiment of this application;

FIG. 16A is an exploded view of still yet another antenna structure according to an embodiment of this application;

FIG. 16B is a sectional view of the antenna structure in FIG. 16A in a direction B-B;

FIG. 16C is a diagram of an antenna array assembly, a mounting base, a waterproof member, and a first connecting member in FIG. 16A in a direction C;

FIG. 17 is a diagram of a structure of another communication device according to an embodiment of this application; and

FIG. 18 is an exploded view of an antenna structure and a remote radio unit of another communication device according to an embodiment of this application.

### REFERENCE NUMERALS

01—communication system architecture; 02—communication device; 10—antenna structure; 11—radome; 111—first accommodating cavity; 112—first connecting hole; 113—first inner wall; 114—second fastening hole; 115—third fastening hole; 12—antenna array assembly; 121—radiation surface; 122—back surface; 123—preset port; 1231—terminal; 124—radiating element; 125—reflector; 126—feed network; 13—mounting base; 131—mounting base body; 1311—second accommodating cavity; 1312—first groove wall; 1313—second groove wall; 1314—mounting hole; 132—mounting bracket; 1321—assembly space; 133—flange; 1331—first fastening hole; 134—reinforcing rib; 14—connector; 15—first cable; a1—first end of the first cable; a2—second end of the first cable; 16—waterproof member; 161—waterproof member body; 1611—second connecting hole; 1612—through hole; 162—boss; 17—first connecting member; 18—support frame; 19—second connecting member; 101—first sealing member; 102—second sealing member; 20—communication bracket; 21—pole; 22—adjusting arm; 23—fixture; 30—second cable; 40—remote radio unit; 50—support base; 51—fourth fastening hole; 03—terminal device.

### DESCRIPTION OF EMBODIMENTS

The following describes technical solutions in embodiments of this application with reference to accompanying drawings in embodiments of this application. It is clear that the described embodiments are merely some rather than all of embodiments of this application.

In the following descriptions, terms such as “first”, “second”, “third”, and “fourth” are merely used for ease of description, and shall not be understood as an indication or an implication of relative importance or an implicit indication of a quantity of indicated technical features. Therefore, a feature limited by “first”, “second”, “third”, “fourth”, or the like may explicitly or implicitly include one or more features. In descriptions of this application, unless otherwise stated, “a plurality of” means two or more than two.

In this application, unless otherwise expressly specified and limited, the term “connection” should be understood in a broad sense. For example, “connection” may be a fixed mechanical connection, or may be a detachable mechanical connection or an integrally formed connection. Alternatively, “connection” may be a direct connection, or may be an indirect connection via an intermediate medium.

In embodiments of this application, the term “example” is used to represent giving an example, an illustration, or a description. Any embodiment or design scheme described as an “example” in embodiments of this application should not be explained as being more preferred or having more advantages than another embodiment or design scheme. Specifically, use of the term “example” or the like is intended to present a related concept in a specific manner.

In the accompanying drawings of embodiments of this application, an assembly is represented by using a guideline with an arrow, a component is represented by using only a guideline, and a hollow structure like an opening or a hole is represented by using a guideline with a straight line at an end.

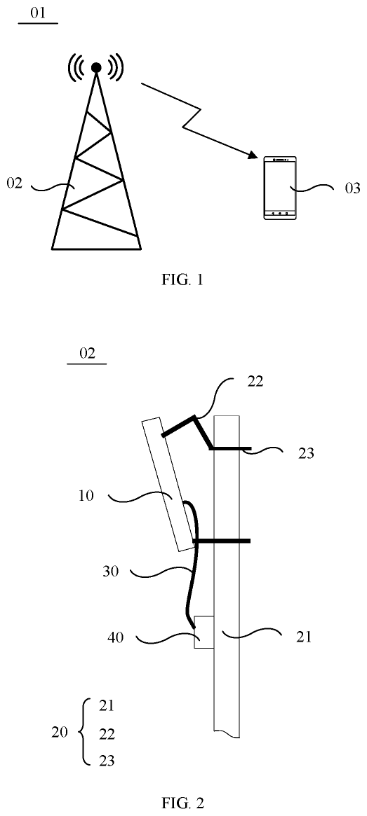

An embodiment of this application provides a communication system architecture 01. As shown in FIG. 1, the communication system architecture 01 may include a communication device 02 and a terminal device 03. The communication device 02 may perform wireless communication with the terminal device 03. For example, the communication device 02 may include a base station. The base station is configured to provide cell coverage for a wireless signal, to implement connection between the terminal device and a wireless network radio frequency end. Based on this, for example, the base station may be a base transceiver station (base transceiver station, BTS) in a global system for mobile communications (global system for mobile communications, GSM) or a code division multiple access (code division multiple access, CDMA) system. Alternatively, for another example, the base station may be a NodeB (NodeB, NB) in a wideband code division multiple access (wideband code division multiple access, WCDMA) system. Alternatively, for still another example, the base station may be an evolved NodeB (evolved NodeB, eNB) in a long term evolution (long term evolution, LTE) system, or a radio controller in a cloud radio access network (cloud radio access network, CRAN) scenario. Alternatively, the base station may be a relay station, an access point, a vehicle-mounted device, a wearable device, or a base station in a 5G network, or may be a base station in a future evolved public land mobile network (public land mobile network, PLMN) or the like, for example, a new radio base station. This is not limited in embodiments of this application.

In addition, the terminal device 03 may be a mobile phone (mobile phone), a tablet computer (pad), a notebook computer, a smart home, a smart wearable device (for example, a smartwatch, a smart band, smart glasses, or a smart helmet), a virtual reality (virtual reality, VR) device, an augmented reality (augmented reality, AR) device, or the like. Alternatively, the terminal device 03 may be a handheld terminal device with a wireless communication function, a computing device or another processing device connected to a wireless modem, a vehicle-mounted device, a device in a 5G network, a terminal device in a future evolved PLMN, or the like. This is not limited in embodiments of this application.

When the communication device 02 is a base station, in some embodiments of this application, the communication device 02 may include an antenna structure 10, a communication bracket 20, a second cable 30, and a remote radio unit 40 that are shown in FIG. 2. The antenna structure 10 and the remote radio unit 40 are separately disposed on the communication bracket 20. One end of the second cable 30 may be electrically connected to the antenna structure 10, and the other end of the second cable 30 may be electrically connected to the remote radio unit 40. The antenna structure 10 performs signal transmission with the remote radio unit 40 via the second cable 30, and the remote radio unit 40 is configured to transmit a radio frequency signal.

For example, the communication bracket 20 may include a pole 21, and the pole 21 may fasten and support the antenna structure 10. In addition, the communication bracket 20 may further include an adjusting arm 22 and a fixture 23. The adjusting arm 22 is located between the antenna structure 10 and the pole 21. One end of the fixture 23 is connected to the adjusting arm 22, and the other end of the fixture 23 is connected to the pole 21. The antenna structure 10 may be connected to the pole 21 sequentially through the adjusting arm 22 and the fixture 23. The adjusting arm 22 may adjust a pitch angle of the antenna structure 10 relative to the pole 21.

As shown in FIG. 2, the foregoing embodiment uses an example in which the remote radio unit 40 is disposed on the pole 21. In another embodiment of this application, the remote radio unit 40 may alternatively be disposed at a position close to the antenna structure 10, such as a tower or a rooftop.

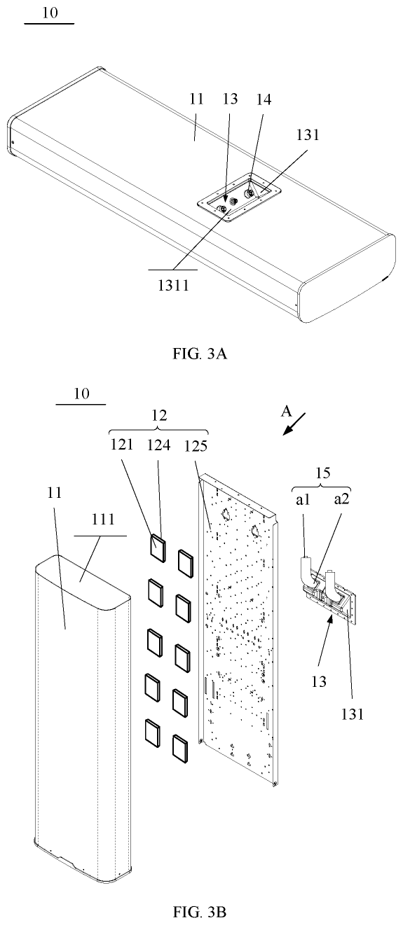

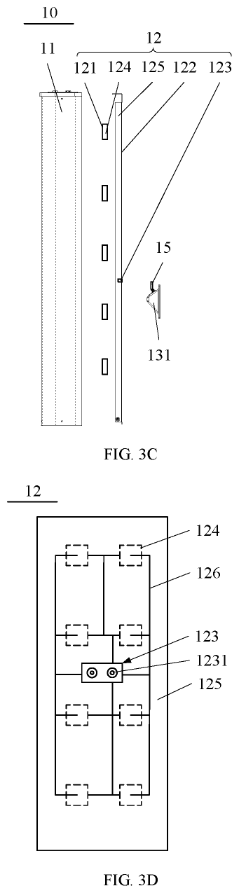

Based on this, in some embodiments of this application, as shown in FIG. 3A, the antenna structure 10 may include a radome 11, a connector 14, and a mounting base 13. The mounting base 13 includes a mounting base body 131. The mounting base body 131 has a second accommodating cavity 1311 for accommodating the connector 14. After the connector 14 is disposed in the second accommodating cavity 1311, the mounting base body 131 can accommodate and protect the connector 14. On this basis, the connector 14 shown in FIG. 3A may be an MQ quick-connect connector or a DIN connector.

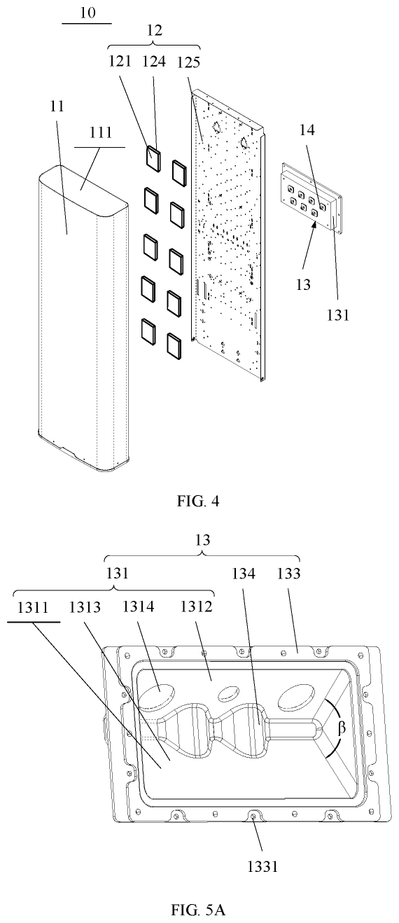

As shown in FIG. 3B or FIG. 4, the antenna structure 10 may include an antenna array assembly 12. The radome 11 has a first accommodating cavity 111 for accommodating the antenna array assembly 12 and the mounting base 13. The radome 11 can resist impact of an external environment of the antenna structure 10, and protect the antenna array assembly 12 and the mounting base 13 that are disposed in the first accommodating cavity 111.

As shown in FIG. 3C, the antenna array assembly 12 has a radiation surface 121, a back surface 122 that faces away from the radiation surface 121, and a preset port 123 located on the back surface 122. The antenna array assembly 12 may receive a radio wave through the radiation surface 121, and send a radio frequency signal to the connector 14 through the preset port 123. Alternatively, the antenna array assembly 12 may receive a radio frequency signal from the connector 14 through the preset port 123, and then transmit a radio wave through the radiation surface 121. To help the antenna array assembly 12 transmit, to the outside through the preset port 123, all radio wave signals received in different regions of the radiation surface 121, based on a distribution status of each component in the antenna structure 10, the preset port 123 may be disposed at a position that is on the back surface 122 and that is close to the center. In this case, the preset port 123 is electrically connected to the connector 14. A radio frequency signal is transmitted to the connector 14, and the radio frequency signal is transmitted to the preset port 123 of the antenna array assembly 12 through the connector 14, so that the antenna array assembly 12 transmits a radio wave through the radiation surface 121. Therefore, the antenna structure 10 can transmit the radio wave. When the antenna array assembly 12 receives a radio wave through the radiation surface 121, the antenna array assembly 12 sends a radio frequency signal to the connector 14 through the preset port 123, and transmits the radio frequency signal to the remote radio unit 40 (as shown in FIG. 2) through the connector 14. Therefore, the antenna structure 10 can receive a radio wave signal. In this case, the mounting base 13 is disposed close to the preset port 123, so that a distance between the connector 14 and the preset port 123 is reduced, and therefore a signal transmission loss between the connector 14 and the preset port 123 can be reduced. In this way, the transmission loss in the antenna structure is reduced.

In some embodiments of this application, as shown in FIG. 4, an end that is of the connector 14 and that is close to the antenna array assembly 12 may be directly electrically connected to the preset port 123 (as shown in FIG. 3C). In a related technology, a connector disposed at a bottom of an antenna structure needs to be electrically connected to a preset port on a back surface by using a feeder, and a length of the feeder configured to electrically connect the connector to the preset port needs to be greater than a distance between a bottom of a radome and the preset port. Consequently, the length of the feeder is long, and a transmission loss is high. However, in this embodiment of this application, a disposition position of the mounting base 13 is adjusted, to enable the mounting base 13 to be close to the preset port 123, so that the connector 14 can be directly electrically connected to the preset port 123 without using a cable or another transmission medium. When radio frequency is transferred between the preset port 123 and the connector 14, no path loss is caused. In this way, the transmission loss in the antenna structure 10 is further reduced.

In some other embodiments of this application, as shown in FIG. 3B, the antenna structure 10 may include a first cable 15 disposed in the first accommodating cavity 111. A first end a1 of the first cable 15 is electrically connected to the preset port 123, and a second end a2 of the first cable 15 is electrically connected to the connector 14 (as shown in FIG. 3A). In this case, as shown in FIG. 3C, the preset port 123, the first cable 15, and the connector 14 are electrically connected in sequence, so that a radio frequency signal can be transmitted between the preset port 123, the first cable 15, and the connector 14. The mounting base 13 is disposed close to the preset port 123, so that the distance between the connector 14 and the preset port 123 is reduced, a required length of the first cable 15 is reduced, and the transmission loss in the antenna structure 10 is reduced. On this basis, still as shown in FIG. 3C, the antenna array assembly 12 may include a reflector 125 and a plurality of radiating elements 124 arranged in an array. Each radiating element 124 includes a radiator, and the radiator may radiate or receive a radio wave. The radiation surface 121 of the antenna array assembly 12 is a radiation surface of the radiator of the radiating element 124, and the back surface of the antenna array assembly 12 is an end face that is of the reflector 125 and that faces away from the radiation surface 121. Certainly, a component that is of the antenna array assembly 12 and that is far away from the radiation surface 121 may also protrude beyond the back surface 122. In addition, the reflector 125 further has a reflective surface, and the reflective surface is an end face facing the radiation surface 121. When the radiating element 124 receives a radio wave, the reflective surface of the reflector 125 may reflect the radio wave, so that the radio wave is aggregated at a receiving point of the radiating element 124, thereby enhancing a receiving capability of the radiating element 124. In addition, the reflector 125 may further block and shield another electromagnetic wave from the back surface, to prevent the another electromagnetic wave from the back surface from interfering with receiving effect of the radiating element 124.

In addition, as shown in FIG. 3D, the antenna array assembly 12 may further include a feed network 126. The feed network 126 is electrically connected to the radiator of the radiating element 124, and the feed network 126 is electrically connected to the preset port 123. In other words, a radiator of each radiating element 124 is electrically connected to the preset port 123 through the feed network 126. After receiving a radio wave, any radiator of the radiating element 124 can transmit a radio frequency signal to the preset port 123 through the feed network 126, and then the preset port 123 transmits the radio frequency signal to the remote radio unit 40 through the first cable 15 and the connector 14. When a radio wave needs to be transmitted through the radiator of the radiating element 124, the remote radio unit 40 transmits a radio frequency signal to the connector 14. After the radio frequency signal is transmitted to the preset port 123 through the connector 14 and the first cable 15, the radio frequency signal is distributed and transmitted to radiators of the plurality of radiating elements 124 through the feed network 126. The radiators transmit the radio wave to the outside. In this way, the antenna structure can receive or transmit a radio wave, and perform radio frequency signal transmission with the remote radio unit 40.

When the antenna array assembly 12 needs to perform transmission with the remote radio unit 40 (as shown in FIG. 2) on a group of signal transmission paths, the preset port 123 may include one terminal 1231, and the antenna structure 10 may include one connector 14. The connector 14 is directly electrically connected to the terminal 1231, or the connector 14 is electrically connected to the terminal 1231 via one first cable 15.

Alternatively, when the antenna array assembly 12 needs to perform transmission with the remote radio unit 40 (as shown in FIG. 2) on N groups of signal transmission paths, the preset port 123 may include N terminals 1231, and the antenna structure 10 may include N connectors 14. Each connector 14 is electrically connected to one terminal 1231, or each connector 14 is electrically connected to one terminal 1231 via one first cable 15. N is an integer greater than 1. In this case, there are a plurality of signal transmission paths between the preset port 123 and the remote radio unit 40, to transmit a plurality of groups of radio frequency signals. For example, still as shown in FIG. 3D, the preset port 123 may include two terminals 1231, and the antenna structure 10 may include two first cables 15 (as shown in FIG. 3B) and at least two connectors 14 (as shown in FIG. 3A). Each terminal 1231 is electrically connected to one connector 14 via one first cable 15.

In the foregoing embodiment, as shown in FIG. 3D, an example in which the antenna array assembly 12 includes eight radiating elements 124 and one preset port 123 is used. In another embodiment of this application, a quantity of radiating elements 124 may be another quantity, and a quantity of preset ports 123 may be another quantity.

For example, a quantity of preset ports 123 shown in FIG. 3D is at least two. A quantity of connectors 14 (as shown in FIG. 3A) and a quantity of first cables 15 (as shown in FIG. 3B) are both at least two. A quantity of second cables 30 (as shown in FIG. 2) is at least two. The first cables 15 are correspondingly connected to the preset ports 123, so that each preset port 123 is electrically connected to a connector 14 disposed in the second accommodating cavity 1311 (as shown in FIG. 3A) of the mounting base body 131 (as shown in FIG. 3A). Each connector 14 is electrically connected to the remote radio unit 40 (as shown in FIG. 2) via a corresponding second cable 30, so that each preset port 123 can perform signal exchange with the remote radio unit 40 through the corresponding first cable 15, connector 14, and second cable 30. In addition, a midpoint between two preset ports 123 that are farthest from each other is a first position, and a distance between the mounting base 13 (as shown in FIG. 3A) and the first position is less than a distance between the mounting base 13 and any preset port 123. In this case, the mounting base 13 is located between the at least two preset ports 123, and a sum of distances between the mounting base 13 and the preset ports 123 is small, so that a required total length of the first cables 15 is reduced, and the transmission loss is reduced.

To further reduce a transmission loss between the connector 14 and the preset port 123, as shown in FIG. 5A, the mounting base body 131 may be provided with a mounting hole 1314. The end that is of the connector 14 (as shown in FIG. 3A) and that is close to the antenna array assembly 12 (as shown in FIG. 3B) may pass through the mounting hole 1314 and be electrically connected to the preset port 123. In this way, the mounting hole 1314 is provided at a position that is of the mounting base body 131 and that is close to the preset port 123, so that it is ensured that the connector 14 can be directly electrically connected to the preset port 123, and therefore the transmission loss is reduced. Alternatively, when the connector 14 and the preset port 123 need to be connected via the first cable 15, the first cable 15 does not need to bypass the mounting base body 131 or extend into the second accommodating cavity 1311, and may be electrically connected to the connector 14 on an outer side of the mounting base body 131, so that the length of the first cable 15 can be further reduced, and a transmission loss of the first cable 15 can be further reduced.

In some embodiments of this application, still as shown in FIG. 5A, the second accommodating cavity 1311 of the mounting base body 131 may be a groove, and an opening of the groove faces away from the back surface. The groove has a first groove wall 1312 on a side close to the preset port 123 (as shown in FIG. 3C), and the first groove wall 1312 is provided with the mounting hole 1314. After the end of the connector 14 passes through the mounting hole 1314 on the first groove wall 1312, the end of the connector 14 exceeds a side wall of the groove, and is electrically connected to the preset port 123. In addition, because the first groove wall 1312 is on the side that is of the groove and that is close to the preset port 123, a distance between the preset port 123 and the end that is of the connector 14 and that passes through the mounting hole 1314 is short, so that a signal transmission loss between the preset port 123 and the connector 14 can be reduced.

On this basis, as shown in FIG. 5B, a first included angle α is formed between a plane on which the first groove wall 1312 is located and the back surface 122, an opening of the first included angle α faces the preset port 123, and 0°<α≤90°. For example, the first included angle α may be 5°, 25°, 45°, 65°, 80°, 90°, or the like. When the connector 14 needs to be electrically connected to the preset port 123 via the first cable 15, the opening of the first included angle α between the first groove wall 1312 and the back surface 122 faces the preset port 123. In other words, the preset port 123, the end that is of the connector 14 (as shown in FIG. 3A) and that passes through the mounting hole 1314, and the first cable 15 (as shown in FIG. 3B) configured to connect the preset port 123 and the connector 14 are all located on a same side of the first groove wall 1312. In this case, a required length of the first cable 15 is short.

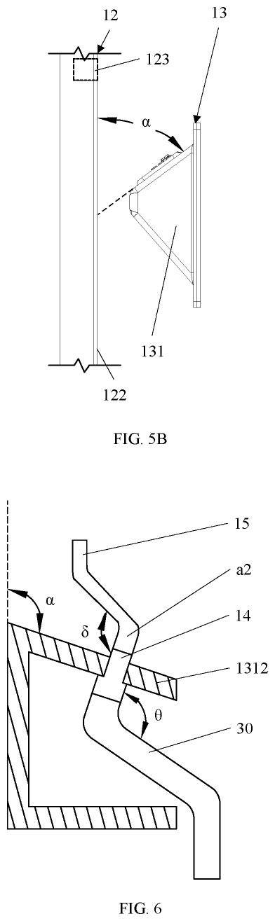

When the first included angle α is greater than 90°, as shown in FIG. 6, an extension direction of the second end a2 of the first cable 15 needs to face the back surface 122 (as shown in FIG. 3C). When the first cable 15 is connected to the connector 14, the first cable 15 needs to be first bent in a direction facing away from the back surface 122, and then bent in a direction facing the back surface 122. That is, the first cable 15 needs to be bent at least twice. In addition, a bending angle δ of the first cable 15 at a connection portion with the connector 14 is small, and a bending degree is large. In this case, mounting is inconvenient, and a required length of the first cable 15 is long. In addition, when the second cable 30 (as shown in FIG. 2) is connected to the outside, the second cable 30 also needs to be bent at least twice, a bending angle θ at a connection portion between the second cable 30 and the connector 14 is small, and a bending degree is large, which are inconvenient for mounting of the second cable 30 and the connector 14.

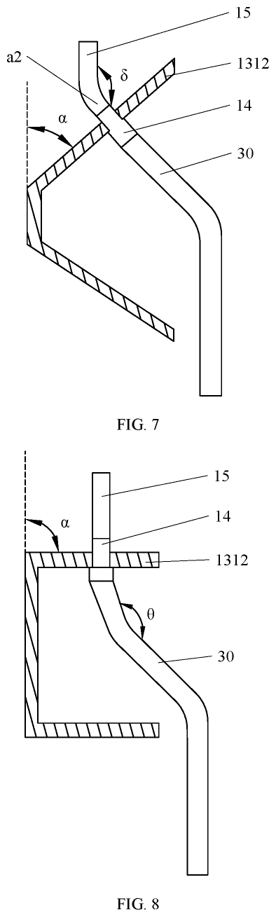

When 0°<α<90°, as shown in FIG. 7, an end that is of the first groove wall 1312 and that is away from the back surface 122 is inclined toward the preset port 123. After the end of the connector 14 passes through the mounting hole 1314, an extension direction of the end that is of the connector 14 and that passes through the mounting hole 1314 faces the back surface 122, and an extension direction of the second end a2 of the first cable 15 configured to electrically connect to the connector 14 faces away from the back surface 122. To be electrically connected to the connector 14, the first cable 15 needs to be bent only once in a direction facing away from the back surface. After bending, an angle δ at a bent portion is large, and a bending degree is small, so that bending is easy. In addition, the second cable 30 needs to be bent only once at a connection portion with the connector 14, which facilitates mounting of the second cable 30.

When α=90°, as shown in FIG. 8, the first groove wall 1312 is perpendicular to the back surface 122, and an axis of the mounting hole 1314 provided on the first groove wall 1312 is parallel to the back surface 122. After the end of the connector 14 passes through the mounting hole 1314, an extension direction of the connector 14 is parallel to the back surface 122. In addition, the end that is of the connector 14 and that passes through the mounting hole 1314, the preset port 123, and the first cable 15 are all located on the same side of the first groove wall 1312. In this case, when the first cable 15 communicates with the connector 14 and the preset port 123, an extension direction of the second end a2 of the first cable 15 is parallel to the back surface 122. In other words, the first cable 15 can be connected to the connector 14 without bending. In addition, a bending angle θ of the second cable 30 at a connection portion with the connector 14 is large, and a bending degree is small, so that bending is easy, which facilitates mounting of the second cable 30.

In conclusion, in the antenna structure provided in this embodiment of this application, the first included angle α between the plane on which the first groove wall 1312 is located and the back surface 122 meets 0°<α≤90°. In this case, when the first cable 15 is connected to the connector 14, the first cable 15 does not need to be bent or needs to be bent only once, and an angle δ at a bent portion is large, so that mounting of the first cable 15 and the connector 14 is facilitated, and the length of the first cable 15 can be reduced. Therefore, mounting convenience of the antenna structure can be improved, and the transmission loss of the first cable 15 can be reduced.

Further, still as shown in FIG. 5A, the groove has a second groove wall 1313, there is a second included angle β between the first groove wall 1312 and the second groove wall 1313, and 45°≤β<180°. For example, the second included angle β is 45°, 60°, 90°, 120°, 135°, 150°, 175°, or the like.

When the second included angle β between the first groove wall 1312 and the second groove wall 1313 is less than 45°, the opening of the groove is small. In this case, when the second cable 30 (as shown in FIG. 2) extends into the groove and is connected to the connector, operable space for a worker is small. Consequently, a connection operation is difficult.

However, in the antenna structure provided in this application, the second included angle β between the first groove wall 1312 and the second groove wall 1313 is large, and space at an open end of the groove is large. When the second cable 30 extends into the groove and is connected to the connector 14, operable space for a worker is increased, thereby facilitating mounting and connection of the second cable 30 and the connector 14, and enhancing convenience of mounting and maintenance of the antenna structure and the second cable.

When a plurality of groups of radio frequency signals need to be exchanged between the antenna array assembly 12 (as shown in FIG. 3C) and the remote radio unit 40 (as shown in FIG. 2), or a plurality of signal transmission paths are required, a plurality of connectors 14 (as shown in FIG. 3A) are also required by the antenna structure 10. In this case, when the mounting hole 1314 is provided only on the first groove wall 1312, limited by a size of the mounting base body 131, the first groove wall 1312 may not be able to provide enough mounting holes 1314 for the plurality of connectors 14 to pass through.

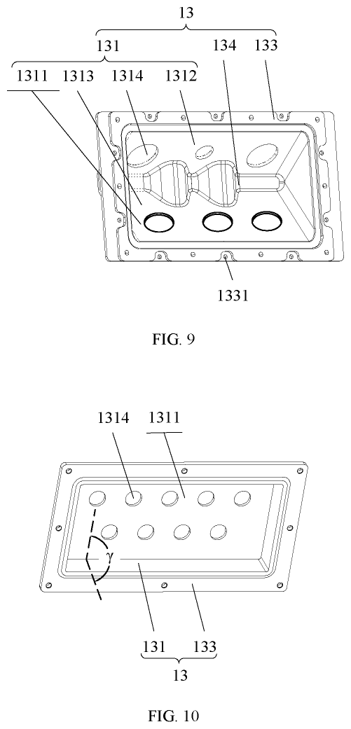

To resolve the foregoing problem, as shown in FIG. 9, the second groove wall 1313 of the mounting base body 131 may be provided with a mounting hole 1314. Ends that are of different connectors 14 and that are close to the antenna array assembly 12 each may pass through the mounting hole 1314 on the first groove wall 1312 or the second groove wall 1313 to connect to the first cable 15, so that it is ensured that all the plurality of connectors 14 can be electrically connected to the preset port 123 (as shown in FIG. 3C).

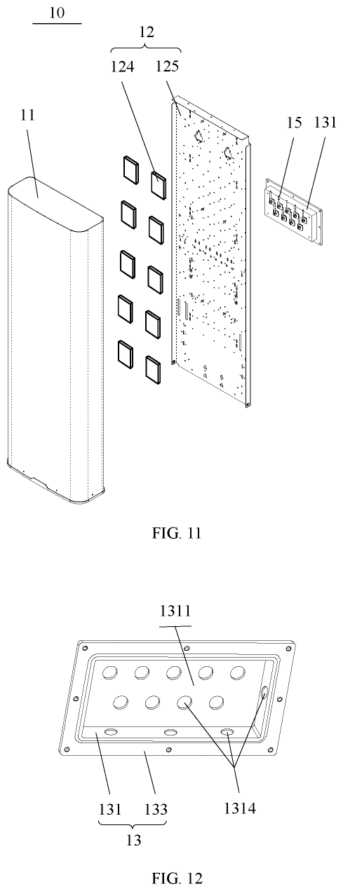

Alternatively, in some other embodiments of this application, the mounting base body 131 may be shown in FIG. 10. A bottom of the groove is provided with the mounting hole 1314, and the bottom of the groove is parallel to the back surface. The antenna structure 10 may be shown in FIG. 11. The connector 14 (as shown in FIG. 3C) is perpendicular to the back surface 122 (as shown in FIG. 3C) and disposed at the bottom of the groove. When the groove has a small depth, the connector 14 may be accommodated in the groove, so that space occupied by the mounting base body 131 is reduced, and arrangement and assembly of internal components of the antenna structure 10 are facilitated. In addition, as shown in FIG. 4, when the mounting base 13 is located right above the preset port 123, the connector 14 is perpendicular to the back surface 122, so that the connector 14 is directly electrically connected to the preset port 123.

On this basis, still as shown in FIG. 10, the groove has a plurality of groove walls, there is a third included angle γ between the groove wall and the bottom, and 80°≤γ<100°. For example, the third included angle γ is 80°, 85°, 90°, 95°, or 100°. In this case, the groove wall is approximately perpendicular to the bottom, and the groove has a shape approximately of a cuboid. In a direction parallel to the back surface 122, assembly space of the mounting base 13 is limited. In other words, when a projection area of the mounting base body 131 on the back surface 122 is the same, and the third included angle between the groove wall and the bottom is within this range, space of the groove is large, and a large quantity of connectors 14 can be accommodated, so that the groove can accommodate more connectors 14, to meet a transmission requirement of a radio frequency signal of the antenna array assembly 12 (as shown in FIG. 3C).

Further, to enable the mounting base body 131 to accommodate more connectors 14 and ensure that an end of the connector 14 can pass through the mounting hole 1314 and be electrically connected to the preset port 123, as shown in FIG. 12, the groove wall of the groove may be provided with a mounting hole 1314. The connectors 14 of the antenna structure 10 (as shown in FIG. 3A) each can be mounted to the bottom or the groove wall, so that the groove can accommodate more connectors 14.

For ease of illustration, the following descriptions are provided by using an example in which the mounting base body 131 of the mounting base 13 is shown in FIG. 5A and the second accommodating cavity 1311 is a groove.

Still as shown in FIG. 5A, the mounting base 13 further includes a flange 133, and the flange 133 is fastened to the open end of the groove. In this case, the flange 133 is disposed on a peripheral side of the open end of the groove, and does not block the opening of the groove, so that connection space between the connector 14 (as shown in FIG. 3A) and the external cable (as shown in FIG. 2) in the groove is ensured. In addition, the flange 133 is connected to the radome 11 (as shown in FIG. 3A). For example, the flange 133 may be provided with a hole, and the flange 133 and the radome 11 are fastened relative to each other by using a connecting member. Alternatively, glue is applied to the flange 133, so that the flange 133 is bonded to the radome 11. Regardless of the manner, the flange 133 can increase an area of a connection portion between the mounting base 13 and the radome 11, to facilitate hole forming or glue application on the flange 133, and ensure that the mounting base 13 is connected to the radome 11.

To ensure structural stability of the mounting base, still as shown in FIG. 5A, the mounting base 13 further includes a reinforcing rib 134 connected to at least one of the first groove wall 1312 and the second groove wall 1313. For example, the reinforcing rib 134 may be connected to the first groove wall 1312. Alternatively, the reinforcing rib 134 may be connected to the second groove wall 1313. Alternatively, the reinforcing rib 134 is connected to the first groove wall 1312, and the reinforcing rib 134 is connected to the second groove wall 1313. The reinforcing rib 134 improves connection rigidity between the first groove wall 1312 and the second groove wall 1313, to improve structural stability of the mounting base 13.

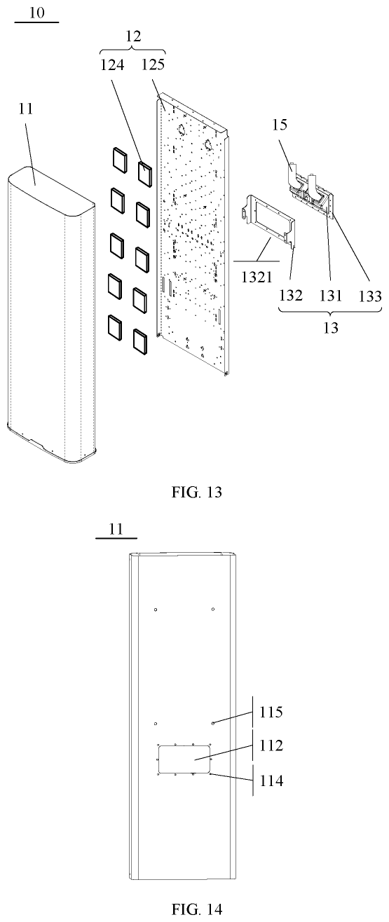

In addition, as shown in FIG. 13, the mounting base 13 may include a mounting bracket 132. The mounting bracket 132 is fastened relative to the mounting base body 131, to support the mounting base body 131. In addition, the mounting bracket 132 may be disposed on a side that is of the mounting base body 131 and that is close to the antenna array assembly 12, and the mounting bracket 132 is connected to the antenna array assembly 12. In this way, the mounting base body 131 may be fastened relative to the antenna array assembly 12 through the mounting bracket 132. In addition, the mounting bracket 132 may further increase a distance between the mounting base body 131 and the antenna array assembly 12, to enable the connector 14 (as shown in FIG. 3A) in the second accommodating cavity 1311 (as shown in FIG. 3B) to be closer to an inner wall of the radome 11, so that the connector 14 is connected to the second cable 30 (as shown in FIG. 2) located on a side of an outer wall of the radome 11.

Further, still as shown in FIG. 13, the mounting bracket 132 may have assembly space 1321 for accommodating the mounting base body 131. The assembly space 1321 is space enclosed by a framework of the mounting bracket 132. After the mounting base body 131 is disposed in the assembly space 1321, the mounting bracket 132 can protect the mounting base body 131. Especially, when the mounting base body 131 has low hardness, the mounting bracket 132 can prevent connection stability between the connector 14 (as shown in FIG. 3A) and the mounting base body 131 from being affected by deformation of the mounting base body 131 due to force in an assembly process of the antenna structure 10, which further affects connection effect between the connector 14 and the preset port 123 (as shown in FIG. 3C) or the second cable 30 (as shown in FIG. 2).

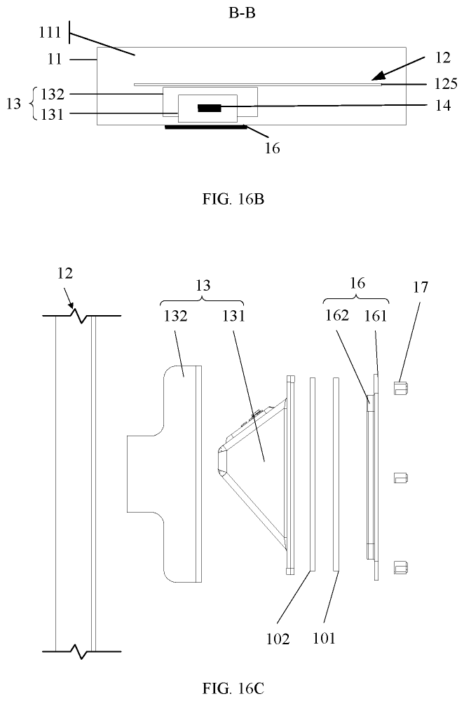

In addition, in the foregoing embodiment, as shown in FIG. 16B, the mounting bracket 132 may be fastened to the reflector 125, to enable the mounting base 13 to be fastened relative to the reflector 125 of the antenna array assembly 12 in the first accommodating cavity 111, so that no relative displacement occurs between the antenna array assembly 12 and the mounting base 13 when the radome 11 is mounted. For example, the mounting bracket 132 is provided with a bracket hole (not shown in the figure), and the reflector 125 is provided with a threaded hole (not shown in the figure). The mounting bracket 132 and the reflector 125 are secured by using a screw (not shown in the figure) that passes through the bracket hole and are threaded into the threaded hole, so that the mounting bracket 132 is finally fastened to the reflector 125.

On this basis, as shown in FIG. 14, the radome 11 may be provided with a first connecting hole 112. The first connecting hole 112 is in communication with the second accommodating cavity 1311 (as shown in FIG. 3A). The second cable (as shown in FIG. 3B) configured to connect the remote radio unit 40 (as shown in FIG. 2) and the connector 14 (as shown in FIG. 3A) can pass through the first connecting hole 112, extend into the second accommodating cavity 1311 (as shown in FIG. 3A), and then be electrically connected to the connector 14 in the second accommodating cavity 1311. Therefore, during mounting or maintenance, the connector 14 does not need to be pulled out of the radome 11, so that mounting and maintenance convenience of the antenna structure is improved.

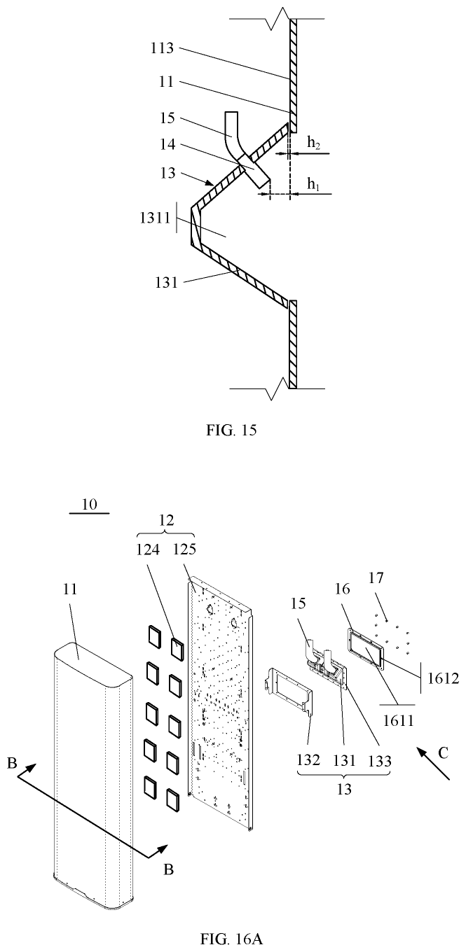

In addition, as shown in FIG. 15, an inner wall of the radome 11 on a side that is of the mounting base 13 and that faces away from the back surface is a first inner wall 113. A distance between the first inner wall 113 of the radome 11 and an end that is of the connector 14 and that faces away from the antenna array assembly 12 is a first distance h₁. A distance between the first inner wall 113 and an end face that is of the mounting base 13 and that is away from the back surface 122 (as shown in FIG. 3C) is a second distance h₂. In addition, h₁ is greater than or equal to h₂. In other words, after the connector 14 is mounted in the second accommodating cavity 1311 of the mounting base body 131, the connector 14 does not protrude beyond the end face of the mounting base 13. In a process of assembling the antenna structure 10, the mounting base 13 avoids direct contact between the connector 14 and the radome 11, and further avoids friction between the connector 14 and the inner wall of the radome 11. Therefore, in a process of assembling the radome 11, passive intermodulation caused by repeated friction between the radome 11 and the connector 14 is avoided.

In any one of the foregoing embodiments, the connector 14 shown in FIG. 15 and the mounting base body 131 are connected in a sealed manner at the mounting hole 1314 (as shown in FIG. 5A). It is ensured that the groove is sealed relative to the first accommodating cavity 111 (as shown in FIG. 3B) of the radome 11 at the mounting hole 1314, to prevent moist air in the groove from entering the first accommodating cavity 111, which affects performance of the antenna structure.

For example, a sealing ring (not shown in the figure) is disposed on the mounting base body 131 at the mounting hole 1314, and the sealing ring is sleeved at the end that is of the connector 14 and that is close to the antenna array assembly 12; or an inner wall of the mounting hole 1314 is coated with sealant, and the end that is of the connector 14 and that is close to the antenna array assembly 12 is connected to the inner wall of the mounting hole 1314 in a sealed manner by using the sealant.

In addition, as shown in FIG. 16A, the antenna structure 10 may include a waterproof member 16. As shown in FIG. 16B, the waterproof member 16 may be disposed on an outer side of a panel that is of the radome 11 and that has the first connecting hole 112 (as shown in FIG. 10).

As shown in FIG. 16C, the waterproof member 16 may include a waterproof member body 161. The waterproof member body 161 is provided with a second connecting hole 1611 (as shown in FIG. 16A). The second connecting hole 1611 is in communication with the first connecting hole 112, and the second cable 30 (as shown in FIG. 2) can be electrically connected to the connector 14 after sequentially passing through the second connecting hole 1611 and the first connecting hole 112, so that mounting convenience of the second cable 30 is improved.

Still as shown in FIG. 16C, the waterproof member 16 may include a boss 162. The boss 162 may be disposed on a side that is of the waterproof member body 161 and that is close to the mounting base 13. In addition, one end of the boss 162 extends into the first connecting hole 112 and abuts against the mounting base 13. Through this disposition, the boss 162 can block the connection portion between the mounting base 13 and the radome 11, and further improve waterproof performance at the connection portion.

On this basis, the antenna structure 10 shown in FIG. 16C may further include a first sealing member 101. The first sealing member 101 is disposed between the waterproof member 16 and the radome 11, to ensure sealing performance between the waterproof member 16 and the radome 11, and prevent moist air or rainwater from entering the first accommodating cavity 111 (as shown in FIG. 3B) sequentially through a connection portion between the waterproof member 16 and the radome 11 and the connection portion between the radome 11 and the mounting base 13. For example, the first sealing member 101 may be a waterproof strip, a sealing ring, or the like.

In addition, the antenna structure 10 shown in FIG. 16A further includes a second sealing member 102. The second sealing member 102 is disposed between the mounting base 13 and the radome 11, to ensure sealing performance between the mounting base 13 and the radome 11, and prevent moist air or rainwater from entering the first accommodating cavity 111 (as shown in FIG. 3B) through the connection portion between the radome 11 and the mounting base 13. For example, the second sealing member 102 may be a waterproof strip, a sealing ring, or the like.

Further, still as shown in FIG. 16A, the antenna structure 10 may include a first connecting member 17. As shown in FIG. 5A, the flange 133 of the mounting base 13 may be provided with a first fastening hole 1331. As shown in FIG. 14, the radome 11 is provided with a second fastening hole 114. In this case, the first connecting member 17 sequentially passes through the second fastening hole 114 and the first fastening hole 1331, and is fastened to the flange 133 of the mounting base 13, to apply force bringing the mounting base 13 and the radome 11 closer to each other, so that the mounting base 13 and the radome 11 are fastened relative to each other, and the second sealing member 102 is squeezed (as shown in FIG. 16C). In this way, sealing performance of the connection portion between the mounting base 13 and the radome 11 is improved.

For example, the first connecting member 17 may be a bolt or a screw, and the first fastening hole 1331 may be a threaded hole. After passing through the second fastening hole 114, the first connecting member 17 is threaded into the first fastening hole 1331, so that it is ensured that the mounting base 13 is fastened to the radome 11.

Alternatively, the first connecting member 17 is a pin, and the first fastening hole 1331 is a pin hole. After passing through the second fastening hole 114, the first connecting member 17 is connected to the first fastening hole 1331 in an interference fit, so that it is ensured that the mounting base 13 is fastened to the radome 11.

On this basis, still as shown in FIG. 16A, the waterproof member 16 is provided with a through hole 1612. The first connecting member 17 sequentially passes through the through hole 1612, the second fastening hole 114, and the first fastening hole 1331 on the waterproof member 16, and is fastened to the flange 133 of the mounting base 13, to apply force bringing the waterproof member 16 and the radome 11 closer to each other, so that the waterproof member 16 and the radome 11 are fastened relative to each other, and the first sealing member 101 (as shown in FIG. 16C) is squeezed. In this way, sealing performance of the connection portion between the waterproof member 16 and the radome 11 is improved.

In addition, in the foregoing embodiment, a peripheral side of the first connecting member 17 may be coated with sealant, to ensure sealing performance between the first connecting member 17 and the first fastening hole 1331 or the second fastening hole 114.

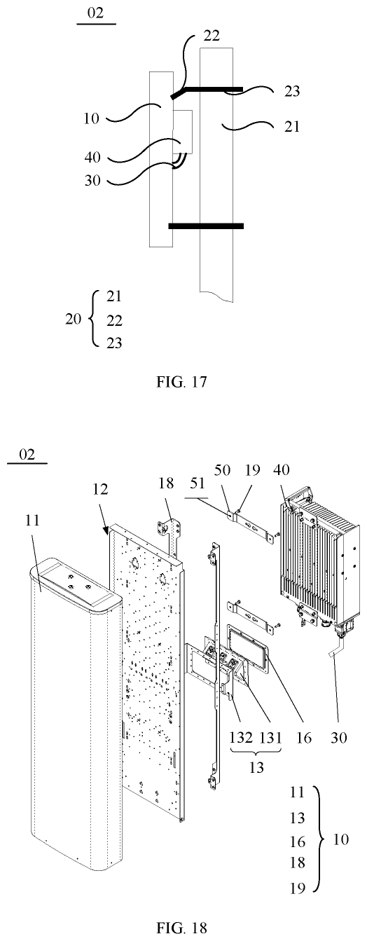

In some other embodiments of this application, the remote radio unit 40 of the communication device 02 may be disposed, as shown in FIG. 17, on a side wall that is of the antenna structure 10 and that is close to the communication bracket 20. In this way, a distance between the remote radio unit 40 and the antenna structure 10 is short, and a length of the second cable 30 configured to connect the remote radio unit 40 and the antenna structure 10 is short, so that a signal transmission loss in the second cable 30 is reduced.

Based on this, in some embodiments of this application, as shown in FIG. 18, the antenna structure 10 may include a support frame 18 and a second connecting member 19. In addition, as shown in FIG. 14, the radome 11 is provided with a third fastening hole 115. Still as shown in FIG. 18, one end of the second connecting member 19 passes through the third fastening hole 115 and is fastened to the support frame 18, and the other end of the second connecting member 19 is fastened to the remote radio unit 40. In this way, the remote radio unit 40 and the support frame 18 are fastened relative to each other, and the support frame 18 and the second connecting member 19 support and fasten the remote radio unit 40, to ensure that the remote radio unit 40 is stably disposed on the side wall of the radome 11.

For example, the support frame 18 may be provided with a threaded hole, the second connecting member 19 is a bolt or a screw, and the second connecting member 19 is threaded into the threaded hole on the support frame 18 after passing through the third fastening hole 115, so that the second connecting member 19 is fastened relative to the support frame 18.

Alternatively, the support frame 18 may be provided with a pin hole, and the second connecting member 19 is a pin. After passing through the third fastening hole 115, the second connecting member 19 is connected to the pin hole on the support frame 18 in an interference fit, so that the second connecting member 19 is fastened relative to the support frame 18.

Certainly, still as shown in FIG. 18, the mounting base 13 may alternatively be connected to the support frame 18, and the support frame 18 is connected to the antenna array assembly 12. In this case, the support frame 18 is connected and fastened relative to the antenna array assembly 12. The mounting base 13 and the support frame 18 are connected and fastened relative to each other. In this way, the mounting base 13 and the antenna array assembly 12 are fastened relative to each other, to ensure a stable connection between the mounting base 13 and the antenna array assembly 12.

In the foregoing embodiment, as shown in FIG. 18, an example in which the antenna structure 10 includes four second connecting members 19 is used. In another embodiment of this application, a quantity of second connecting members 19 may be another quantity.

Further, still as shown in FIG. 18, the communication device 02 may further include a support base 50 disposed on an outer wall of the antenna structure 10, the support base 50 is provided with a fourth fastening hole 51, and the second connecting member 19 sequentially passes through the fourth fastening hole 51 and the third fastening hole 115 and is fastened to the support frame 18, so that the support base 50, the second connecting member 19, and the support frame 18 are fastened to each other. In addition, the support base 50 is connected to the remote radio unit 40, so that the remote radio unit 40 is fastened relative to the support base 50, the second connecting member 19, and the support frame 18. Finally, the remote radio unit 40 is fastened to the antenna structure 10, and connection reliability between the remote radio unit 40 and the antenna structure 10 is ensured.

In the foregoing embodiment, as shown in FIG. 18, an example in which the communication device 02 includes two support bases 50 is used. In another embodiment of this application, a quantity of support bases 50 may be another quantity.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An antenna structure, comprising:
a radome, wherein the radome has a first accommodating cavity;
an antenna array assembly, wherein the antenna array assembly is disposed in the first accommodating cavity, the antenna array assembly has a radiation surface and a back surface facing away from the radiation surface, and the antenna array assembly has a preset port;
a mounting base, wherein the mounting base comprises a mounting base body and is disposed in the first accommodating cavity, the mounting base is located on a side on which the back surface of the antenna array assembly is located, and the mounting base body is provided with a second accommodating cavity; and
a connector, wherein the connector is disposed in the second accommodating cavity of the mounting base, and the connector is electrically connected to the preset port.

2. The antenna structure according to claim 1, wherein the antenna structure further comprises a first cable, the first cable is disposed in the first accommodating cavity, a first end of the first cable is electrically connected to the preset port, and a second end of the first cable is electrically connected to the connector.

3. The antenna structure according to claim 1, wherein the mounting base body is provided with a mounting hole; and
an end that is of the connector and that is close to the antenna array assembly passes through the mounting hole, and is electrically connected to the preset port.

4. The antenna structure according to claim 3, wherein the second accommodating cavity is a groove, and an opening of the groove faces away from the back surface; and
the groove has a first groove wall, the first groove wall is provided with the mounting hole, and the first groove wall is a groove wall on a side that is of the groove and that is close to the preset port.

5. The antenna structure according to claim 4, wherein a plane on which the first groove wall is located intersects the back surface, an included angle between the plane on which the first groove wall is located and the back surface is a first included angle α, an opening of the first included angle α faces the preset port, and 0°<α≤90°.

6. The antenna structure according to claim 4, wherein the groove has a second groove wall, there is a second included angle β between the first groove wall and the second groove wall, and 45°≤β<180°.

7. The antenna structure according to claim 6, wherein the second groove wall is provided with a mounting hole.

8. The antenna structure according to claim 6, wherein the mounting base further comprises a reinforcing rib, the reinforcing rib is disposed between the first groove wall and the second groove wall, and the reinforcing rib is connected to at least one of the first groove wall and the second groove wall.

9. The antenna structure according to claim 3, wherein the second accommodating cavity is a groove, and an opening of the groove faces away from the back surface; and
a bottom of the groove is provided with the mounting hole, and the bottom of the groove is parallel to the back surface.

10. The antenna structure according to claim 9, wherein the groove has a plurality of groove walls that intersect with the bottom, and at least one of the groove walls is provided with the mounting hole.

11. The antenna structure according to claim 1, wherein the mounting base further comprises a mounting bracket, the mounting bracket is disposed on a side that is of the back surface and that faces the mounting base body, one end of the mounting bracket is connected to the mounting base body, and the other end is connected to the antenna array assembly.

12. The antenna structure according to claim 11, wherein the mounting bracket has assembly space, and the mounting base body is disposed in the assembly space.

13. The antenna structure according to claim 1, wherein the second accommodating cavity is a groove, and an opening of the groove faces away from the back surface; and the mounting base further comprises a flange, the flange is fastened to an open end of the groove, and the flange is fastened to the radome.

14. The antenna structure according to claim 1, wherein the radome is provided with a first connecting hole, and the first connecting hole is in communication with the second accommodating cavity.

15. The antenna structure according to claim 14, wherein the antenna structure further comprises a waterproof member, the waterproof member is disposed on an outer side of a panel that is of the radome and that has the first connecting hole, the waterproof member comprises a waterproof member body and a boss, the waterproof member body is provided with a second connecting hole, the second connecting hole is in communication with the first connecting hole, the boss is disposed on a side that is of the waterproof member body and that is close to the mounting base, and one end of the boss extends into the first connecting hole and abuts against the mounting base.

16. The antenna structure according to claim 15, wherein the antenna structure further comprises a first sealing member, and the first sealing member is disposed between the waterproof member and the radome.

17. The antenna structure according to claim 1, wherein the antenna structure further comprises a second sealing member, and the second sealing member is disposed between the mounting base and the radome.

18. The antenna structure according to claim 1, wherein the antenna structure further comprises a first connecting member, the mounting base is provided with a first fastening hole, the radome is provided with a second fastening hole, and the first connecting member sequentially passes through the second fastening hole and the first fastening hole and is connected to the mounting base.

19. The antenna structure according to claim 1, wherein the antenna array assembly comprises:
a radiating element;
a reflector, wherein the radiating element is disposed on a side that is of the reflector and that faces away from the back surface, and the preset port is located on a side that is of the reflector and that faces away from the radiating element; and
a feed network, wherein one end of the feed network is electrically connected to the radiating element, and the other end of the feed network is electrically connected to the preset port.

20. The antenna structure according to claim 1, wherein a distance between a first inner wall of the radome and an end that is of the connector and that faces away from the antenna array assembly is a first distance h₁, and a distance between the first inner wall and an end face that is of the mounting base and that is away from the back surface is a second distance h₂, wherein h₁≥h₂, and the first inner wall is an inner wall of the radome on a side that is of the mounting base and that faces away from the back surface.
